(19) United States
(12) Patent Application Publication
(10) Pub. No.: US 2005/0111515 A1
(43) Pub. Date: May 26, 2005

(54) Aerodynamic window for generating and characterizing a filament

(76) Inventor: Jean-Claude Diels, Albuquerque, NM (US)

Correspondence Address: SCHWEGMAN, LUNDBERG, WOESSNER & KLUTH, P.A., P.O. BOX 2938, MINNEAPOLIS, MN, 55402, US

(21) Appl. No.: 10/992,947

(22) Filed: Nov. 19, 2004

Related U.S. Application Data
(60) Provisional application No. 60/524,242, filed on Nov. 21, 2003.

(51) Int. Cl. H01S 3/11

(52) U.S. Cl. 372/104

(57) ABSTRACT

A system and method for launching and characterizing filaments are provided using an aerodynamic window. A filament, a self-induced waveguide in air, is produced by high power laser pulses traversing the atmosphere that can self-focus due to the nonlinear index of refraction of air. At some critical power, self-focusing overcomes diffraction in the atmosphere and the beam collapses until it is balanced by some higher order effect, usually plasma de-focusing. The use of an aerodynamic window provides an opening for a laser beam to propagate between two different atmospheric regions without the use of a solid window, such as between the atmosphere and a vacuum. An aerodynamic window provides a means for controllably launching a filament into the atmosphere. Additionally, an aerodynamic window allows for the characterizing evaluation of a filament without damage to the optical diagnostic tools.

### RELATED APPLICATION

This application claims priority under 35 U.S.C. 119(e) from U.S. Provisional Application Ser. No. 60/524,242 filed Nov. 21, 2003, which application is incorporated herein by reference.

### FIELD OF THE INVENTION

This invention relates generally to self-induced waveguides in the atmosphere.

### BACKGROUND OF THE INVENTION

High power laser pulses traversing the atmosphere can self-focus due to the nonlinear index of refraction of air. At some critical power, self-focusing overcomes diffraction and the beam collapses until it is balanced by some higher order effect, usually, but not exclusively, attributed to plasma de-focusing. This balance can lead to the formation of a filament, a self-induced waveguide in air. Filaments have been seen in the infrared (IR) as well as in the ultraviolet (UV) regime. In both cases, direct measurements have faced a fundamental problem, namely that the high intensity (approx. 1 TW/cm² in the UV and up to 100 TW/cm² in the IR) damages optical components. So far only indirect measurements have been performed, e.g. measuring the damage spot of a UV filament on a piece of film or looking at the light reflected by a glass slide when it is hit by a filament with grazing incidence.

Numerous experiments have shown self-guiding of high peak power femtosecond pulses through the atmosphere. Many experiments were carried out in the near infrared while at least one experiment involved fs pulses at 248 nm. After reaching the focus, the light appeared to trap itself in self-induced waveguides or “filaments” of the order of 100 μm diameter. Since the first report of 1995, several experimental studies on UV filaments have been reported. The energy contained in a single filament is only of the order of a mJ. However, a theoretical study indicates that more energetic filaments (up to 1 J) could be obtained with longer pulses (up to 1 ns) than the sub-picosecond pulses that have been used so far.

Previous studies in this general area have included the following references:
(1) A. Braun, G. Korn, X. Liu, D. Du, J. Squier, and G. Mourou. Self-channeling of high-peak-power fs laser pulses in air. Opt. Lett. 20:73-75, 1994.
(2) Xin Miao Zhao, Jean-Claude Diels, A. Braun, X. Liu, D. Du, G. Korn, G. Mourou, and Juan Elizondo. Use of self-trapped filaments in air to trigger lightning. Ultrafast Phenomena IX, 233-235, Dana Point, Calif., 1994. Springer Verlag, Berlin.
(3) J. Schwarz, P. K. Rambo, J. C. Diels, M. Kolesik, E. ‘Wright, and J. V. Moloney. UV filamentation in air. Optics Comm. 180:383-390, 2000.
(4) A. C. Bernstein, T. S. Luk, T. R. Nelson, A. McPherson, J. C. Diels, and S. M. Cameron. Asymmetric ultra-short pulse splitting measured in air using FROG. Applied Physics B B75(1):119-122, 2002.
(5) J. Schwarz and J. C. Diels. Analytical solution for uv filaments. Phys. Rev. A, 65:013806-1-013806-10, 2001.
(6) A. Braun, G. Korn, X. Liu, D. Du, J. Squier, and G. Mourou. Selfchanneling of high-peak-power fs laser pulses in air. Opt. Lett. 20:73-75, 1994.
(7) Xin Miao Zhao, Patrick Rambo, and Jean-Claude Diels. Filamentation of femtosecond uv pulses in air. QELS 1995, volume 16, page 178 (QThD2), Baltimore, Mass., 1995. Optical Society of America.
(8) E. T. J. Nibbering, P. F. Curley, G. Grillon, B. S. Prade, M. A. Franco, F. Salin, and A. Mysyrowicz. Conical emission from self-guided femtosecond pulses in air. Opt. Lett. 21:62-64, 1996.
(9) A. Braun, G. Korn X. Liu, D. Du, J. Squier, and G. Mourou. Self-channeling of high-peak-power femtosecond laser pulses in air. Optics Lett. 20:73-75, 1995.
(10) B. La Fontaine, F. Vidal, Z. Jiang, C. Y. Chien, D. Comtois, A. Desparois, T. W. Johnston, J. C. Kieffer, and H. Pepin. Filamentation of ultrashort pulse laser beams resulting from their propagation over long distances in air. Physics of Plasmas 6:1615-1621, 1999.
(11) L. Woeste, S. Wedeking, J. Wille, P. Rairouis, B. Stein, S. Nikolov, C. Werner, S. Niedermeier, F. Ronneberger, H. Schillinger, and R. Sauerbrey. Femtosecond atmospheric lamp. Laser und Optoelektronic, 29:51-53, 1997.
(12) P. Rairoux, H. Schillinger, S. Niedermeier, M. Rodriguez, F. Ronneberger, R. Sauerbrey, B. Stein, D. Waite, C. Wedeking, H. Wille, L. Woeste, and C. Ziener. Remote sensing of the atmosphere using ultrashort laser pulses. Appl. Phys. B 71:573-580, 2000.
(13) J. Schwarz, P. K. Rambo, J. C. Diels, M. Kolesik, E. Wright, and J. V. Moloney. Uv filamentation in air. Optics Comm. 180:383-390 2000.
(14) J. Schwarz, P. K. Rambo, and J. C. Diels. UV filaments: Potential for diffractionless high energy beams. Directed Energy for the 21th century; 3rd annual directed energy symposium, November 2000.
(15) J. Schwarz, P. Rambo, and J. C. Diels. Measurements of UV filaments III air. Opto-Southwest, SWO-17, Albuquerque, N. Mex., 2000. OSA.
(16) J. Schwarz, P. Rambo, L. Giuggioli, and J. C. Diels. UV filaments: Great potential for long distance waveguides in air. Nonlinear guided waves and their applications, 467-469, Clearwater, Fla., 2001. OSA.
(17) J. Schwarz and J. C. Diels. Theoretical and experimental studies on uv filaments. CLEO '02, Paper CWH6, Long Beach, Calif., 2002. Optical Society of America.
(18) J. Schwarz and J. C. Diels. Long distance propagation of uv filaments and novel diagnostic tools. Journal of Modern Optics 49:2583-2597, 2002.
(19) J. Schwarz and J. C. Diels. Uv filaments and their application for laser induced lightning and high aspect ratio hole drilling. Applied Physics A, May, 2003.
(20) L. Woeste, S. Wedeking, J. Wille, P. Rairouis, B. Stein, S. Nikolov, C. Werner, S. Niedermeier, F. Ronneberger, H. Schillinger, and R. Sauerbrey. Femtosecond atmospheric lamp. Laser und Optoelektronic 29:51-53, 1997.
(21) Xin Miao Zhao, Patrick Rambo, and Jean-Claude Diels. Filamentation of femtosecond uv pulses in air. QELS 1995, vol. 16, page 178 (QThD2), Baltimore, Mass., 1995. Optical Society of America.
(22) Xin Miao Zhao and Jean-Claude Diels. Filamentation in air: a story of pancakes, spaghetti and bullets. O. Svelto, S. De Silvestri, and G. Denardo, editors Proceedings of the Ninth International Conference on Ultrafast Phenomena in Spectroscopy, 291-294, Trieste, Italy, 1996.
(23) Xin Miao Zhao, Patrick Rambo, and Jean-Claude Diels. Self-trapping, self-focusing and filamentation in air. QELS 1996, QWE1, Anaheim, Calif., 1996. Optical Society of America.
(24) J. Schwarz, P. K. Rambo, J. C. Diels, M. Kolesik, E. Wright, and J. V. Moloney. Uv filamentation in air. Optics Comm. 180:383-390, 2000.
(25) J. C. Diels J. Schwarz, P. K. Rambo, S. Cameron, T. S. Luk, and A. Bernstein. Measurements towards better understanding and/or more confusion about filamentation in air. Proceedings of ICEAA Torino, Italy, 1999. SPIE.

### BRIEF DESCRIPTION OF THE DRAWINGS

Embodiments, aspects, advantages, and features of the present invention will be set forth in part in the description that follows, and in part will become apparent to those skilled in the art by reference to the following description of the invention and referenced drawings or by practice of the invention. The aspects, advantages, and features of the invention are realized and attained by means of the instrumentalities, procedures, and combinations particularly pointed out in these embodiments and their equivalents.

FIG. 1 depicts an embodiment of a system having an electromagnetic source and an aerodynamic window to generate a filament, in accordance with the teachings of the present invention.

FIG. 2 depicts an embodiment of a system having a detector and an aerodynamic window to determine the characteristics of a filament, in accordance with the teachings of the present invention.

FIG. 3 depicts an embodiment of a system using a laser and an aerodynamic window to generate a filament, in accordance with the teachings of the present invention.

FIG. 4 depicts an embodiment of a system having a diagnostic system and an aerodynamic window to characterize a filament, in accordance with the teachings of the present invention.

FIG. 5 illustrates an embodiment of an aerowindow, in accordance with the teachings of the present invention.

In FIG. 6 shows a graph of pressure on the vacuum side versus inlet pressure for three different cases using an aerowindow, in accordance with the teachings of the present invention.

FIG. 7 shows an embodiment of an expanded view of aerodynamic window used for launching or diagnosing filaments, in accordance with the teachings of the present invention.

FIG. 8 shows small holes for passage of the filament in the embodiment of an aerodynamic window of FIG. 7, in accordance with the teachings of the present invention.

FIGS. 9A, 9B illustrate a 3D representation of the plasma plume produced by a filament impinging on steel and a graph indicating the diameter of the hole made by the filaments in a solid material placed at various distances from the source of the filaments.

FIG. 10 depicts an embodiment of an arrangement of a system for studying and measuring parameters of a filament with an aerodynamic window and a CCD, in accordance with the teachings of the present invention.

FIG. 11 depicts an embodiment of a laser system that may be used with an aerodynamic window to launch a filament, in accordance with the teachings of the present invention.

### DETAILED DESCRIPTION

In the following detailed description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that the embodiments may be combined, or that other embodiments may be utilized and that structural, logical and electrical changes may be made without departing from the spirit and scope of the present invention. The following detailed description is, therefore, not to be taken in a limiting sense.

In an embodiment, a system includes a laser source and an aerodynamic window to generate a filament, a self-induced waveguide in air. The filament is the result of a balance between the collapse of a beam of high power laser pulses traversing an atmosphere and a higher order effect within the traversed atmosphere. An aerodynamic window, also referred to as an aerowindow, uses a fluid flow to separate different atmospheric regions without a solid window. The use of an aerodynamic window provides a opening for a laser beam to propagate between two different atmospheric regions without the use of a solid window. In an embodiment, an aerodynamic window uses a supersonic fluid flow such that a pressure gradient across the supersonic fluid flow is adapted for atmospheric pressure on one side of the fluid flow and a vacuum on the other side of the fluid flow. In an embodiment, the supersonic fluid flow is a supersonic air or nitrogen stream. In an embodiment, a region on one side of the supersonic fluid flow has a pressure less than about 50 Torr.

In an embodiment, a system includes an aerodynamic window and a detector to take measurements to characteristic a filament. As a filament passes through the aerodynamic window, its properties are not affected. However, a filament will not subside in a vacuum. In the vacuum, an originally 100 μm diameter beam will become larger by diffraction, and the peak local intensities decrease. After a sufficiently long propagation distance in the vacuum, the filament diameter is sufficiently increased that conventional attenuators (for instance, dielectric coatings) can be used to bring the intensity to a level acceptable without damage to a detector. The detector includes various optical measurement apparatus to characterize the spatial and temporal characteristics of the radiation that it receives such as beam size, energy, and spectrum. These characterizations can be mapped back to determine the characteristics of the filament from which the radiation is derived after propagation through vacuum.

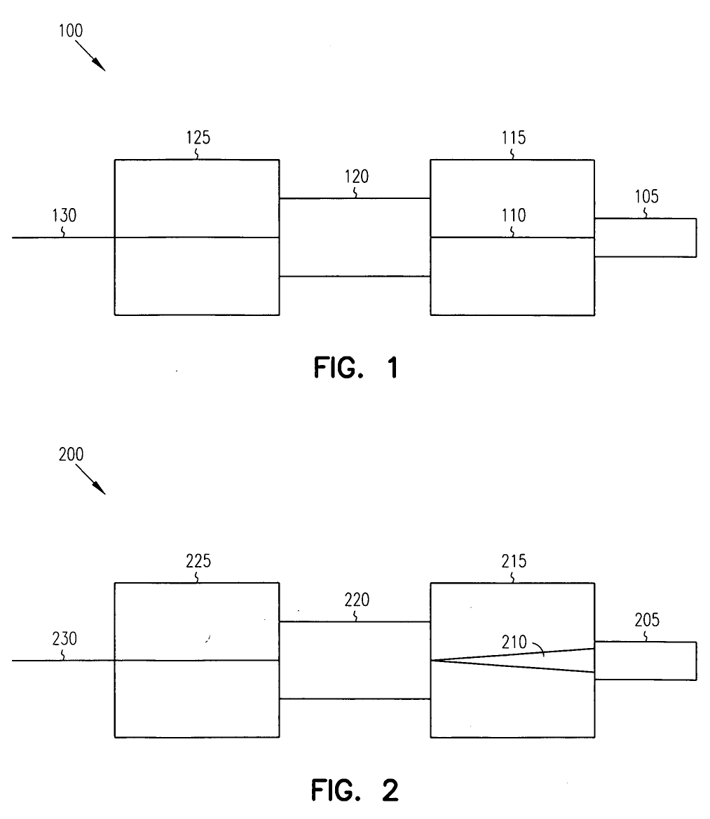

FIG. 1 depicts an embodiment of a system 100 having an electromagnetic source 105 to generate electromagnetic radiation 110 that propagates through a first region 115 through an aerodynamic window 120 into a second region 125 to create a filament 130. Electromagnetic source 105 may be situated in region 115 or spaced apart from region 115. In an embodiment, electromagnetic source 105 includes a laser source to provide a laser beam. System 100 provides a means to create high power filaments in a controllable fashion. In an embodiment, system 100 provides a means to launch a high power filament through a mm size aperture. In an embodiment, system 100 allows for the propagation of high intensity pulses and solitons.

FIG. 2 depicts an embodiment of a system 200 having a detector 205 to receive electromagnetic radiation 210 from propagation through a first region 215 from an aerodynamic window 220 that results from passage of a filament 230 from a second region 225 through aerodynamic window 220. System 200 provides a means to analyze filaments using a technique that allows direct measurement of filament properties such as beam size, energy, and spectrum by using an aerowindow. In an embodiment, the aerowindow 220 allows the filament passing from region 225 to diffract in region 215 such that the electromagnetic radiation 210 has an intensity that allows various diagnostic applications to be applied using nonlinear optics to the received electromagnetic radiation 210.

Embodiments of the present invention include the production, use, and study of ultra-intense laser light pulses in the atmosphere, which are of a sufficient power as to create their own waveguides in air. This phenomenon related to the self creation of waveguides in air has been labeled successively “light bullets, “light strings, “filaments, “self-trapped-filament,” and “self-induced waveguide.” The manifestation is that a high power laser beam collapses into one or more of these channels of approximately 100 μm diameter, in which the light intensity reaches between 10¹² W/cm² (for filaments at uv wavelengths, i.e. wavelengths shorter than 300 nm) to 10¹⁴ W/cm² (for filaments at visible and near IR wavelengths, most typically around 800 nm). It is believed that, under the proper circumstance, these filaments could propagate over distances of several km. The proper circumstances for propagation over such distances are extremely difficult to define, because the formation of filaments is one of the most difficult phenomenon to control. In a general production of filaments, any atmospheric perturbation (air current, thermal convection) would affect the position where a filament is produced, its direction, and whether or not one or more filaments are produced. Various embodiments of the present invention provide for the launching of single and multiple filaments in the atmosphere under controlled conditions due to the use of an aerodynamic window between a vacuum and air to launch the filament or filaments into the atmosphere. As can be understood by those skilled in the art, the aerodynamic window can be used in relation to two controlled environments and is not limited to a configuration between the atmosphere and a vacuum.

The most severe challenge to the controlled production of a single filament is the transition phase between the macroscopic large diameter beam and the self-guided channel. It is during that phase of propagation that the main beam loses most of its energy. It is also during that phase that any atmospheric perturbation may distort the wavefront, distortion that will be amplified by the nonlinear interaction, resulting in a modification of the position or pointing of the filament, or in the formation of multiple filaments. In an embodiment, this problem is addressed by focusing a well corrected plane wave in a vacuum down to about 100 μm onto a vacuum/air interface of an aerodynamic window.

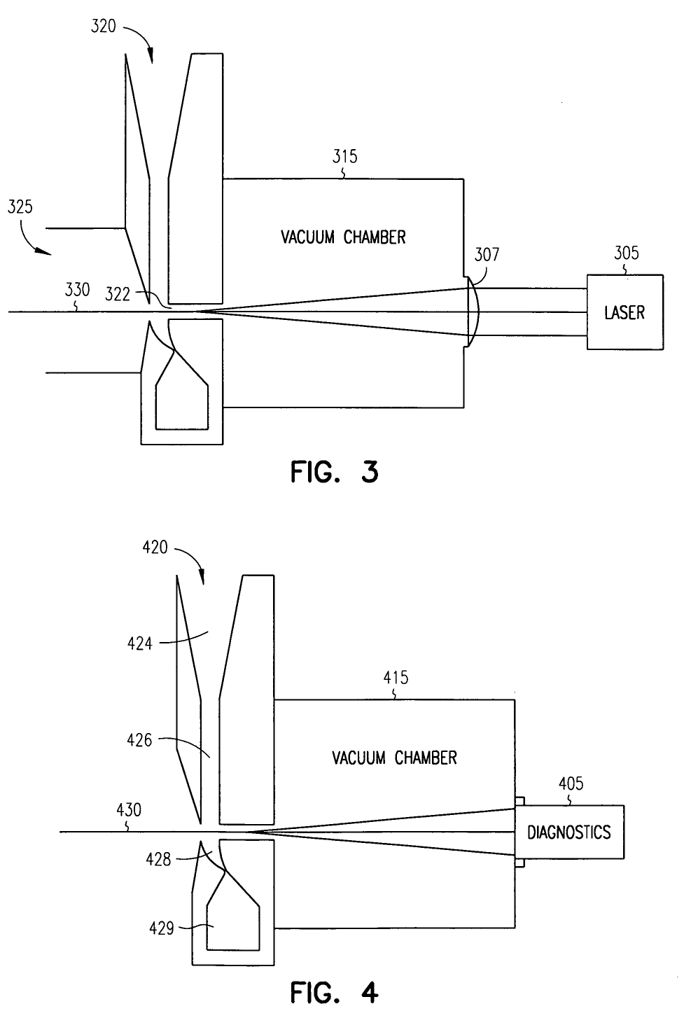

FIG. 3 depicts an embodiment for a geometry to produce single filament 330 through an aerodynamic window 320. Aerodynamic window 320 is used to start a single filament at a beam waist. A focusing lens 307 serves as a window of a vacuum chamber 315. A sufficiently large diameter beam from laser 305 is focused onto aerodynamic window 320 between vacuum 315 and a controlled atmosphere 325. In an embodiment, the aperture 322 of the window is of the order of a mm. In an embodiment, the profile of the laser beam is first filtered to a smooth bell shaped profile, if a single filament has to be produced, or given a precalculated spatial profile, if multiple filaments have to be generated. The filtered “profiled” beam is focused in vacuum, down to a diameter close to that of the filament to be created, or the order of 100 μm. The focal plane of the optics to launch the filaments is located at the vacuum-air interface of an aerodynamic window.

Aerodynamic window 320 provides a unique position to circumvent the highly unstable and uncontrollable formation phase, and in addition enables a system to launch high power filaments in a controlled environment, such as in dry air, at sea level pressure or at high altitude pressure, oxygen or nitrogen. In an embodiment, aerodynamic window 320 can be configured to generate filaments that solve the problem of the large aperture optics needed to launch a high power beam from an airplane, such as required for the airborne iodine laser program. Because the filament does not diffract, instead of an optical port of 30 cm to 1 m in diameter, only a 100 μm diameter aperture of aerodynamic window 320 is required for each filament. In an embodiment, aerodynamic window 320 may be an integral part of an aircraft, from which high power laser beams may be sent. The aircraft may be a supersonic airplane.

A single filament carries a well defined amount of energy. The lethality of a filamented beam will increase with the number of filaments. A beam shaping system, combined with the aerodynamic window, will make it possible to create a predetermined wavefront as an initial condition for the filament leading to the production of a predetermined pattern of filaments.

In an embodiment, use of an aerodynamic window between the atmosphere and vacuum may be used to study the properties of the light inside the filament. One of the main technical difficulties associated with the study of filaments is that air is one of the medium with the lowest non-linearity. Any optical component put in the path of the filament will generally be destroyed. In the rare circumstances that the component is not destroyed, it will generally have a larger influence on the filamented field than air.

Air being one of the media with the highest damage threshold, it is not surprising that laser radiation sufficiently intense to cause high nonlinear response in air will cause severe damage and/or strong self-phase modulation in any solid optical material. It is therefore very difficult to study the properties of the filament, since there is no material that can be used to sample a portion of the field inside a filament.

FIG. 4 depicts an embodiment a system having a diagnostic system 405 and an aerodynamic window 420 to characterize a filament 430. In an embodiment, the aerodynamic window is used between the atmosphere and a vacuum for the purpose of studying the properties of light inside the filament. In an embodiment, a supersonic aerodynamic window may be used to launch filament 430. In vacuum, there is no longer any nonlinear effect that can sustain the filament: it will diffract, and after a sufficient distance will have broadened sufficiently in transverse dimension that the intensity has been reduced to manageable levels. It is then possible to use conventional attenuators, and diagnostics equipment to study the spatial-temporal fields inside the filament. By making it possible to send the filament directly into the vacuum, the aerodynamic window 420 makes it possible to make measurements of the spectrum, duration, and shape of the trapped high intensity pulse. From the diffracted pattern, it is possible to infer the spatial field distribution inside the filament, and make quantitative and accurate comparisons with theoretical calculations.

The aerowindow 420 of FIG. 4 includes a high pressure supply chamber 429, a supersonic vortex nozzle 428, a supersonic diffuser 426, and a subsonic diffuser 424. The supersonic fluid flow of aerowindow 420 provides a pressure gradient between an atmosphere in which filament 430 is propagating and vacuum chamber 415 in which filament 430 can diffract sufficiently to allow characterization of the diffracted electromagnetic radiation detected by the diagnostics 405. The characterization of the diffracted electromagnetic radiation by the diagnostics system 405 provides for the characterization of filament 430. Diagnostic system 405 may include one or more diagnostic tools to provide the determination of a variety of parameters for the characterization of filament 430.

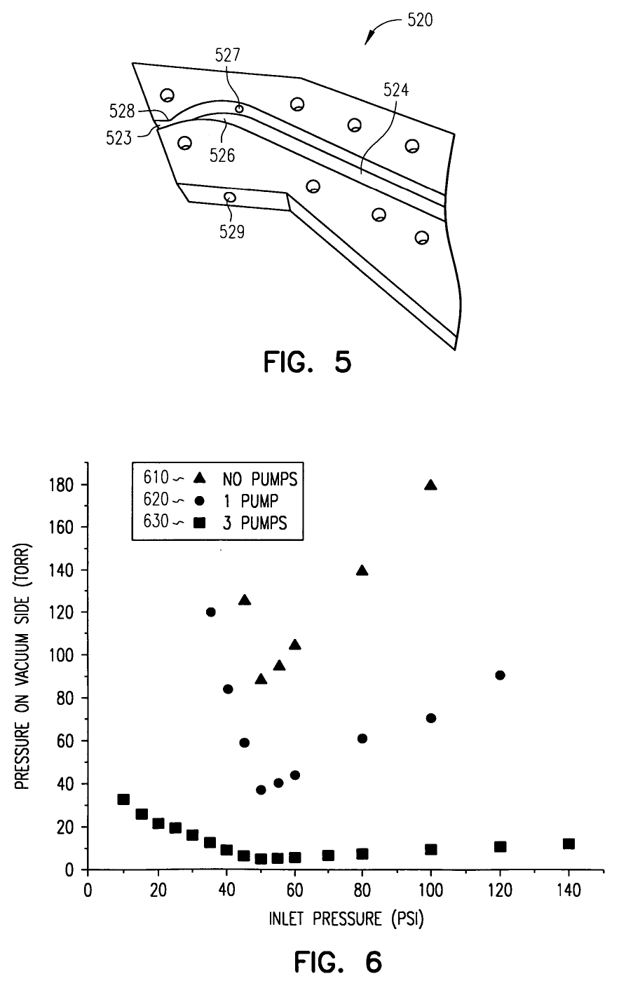

FIG. 5 illustrates an embodiment of an aerowindow 520 with high pressure inlet 523, a nozzle 528, a subsonic diffuser 524, a supersonic flow region 526, a filament entry 527 from the atmosphere, and a filament exit 529 to vacuum. In an embodiment, a filament is sent into a 2.4 m long vacuum tube that is separated from the atmosphere by an aerowindow of FIG. 5. Aerowindow 520 provides an opening for a laser beam to enter the vacuum without going through a solid window. The aerowindow provides a pressure gradient across a supersonic air or nitrogen stream such that the pressure on one side is atmospheric and on the other side less than 50 Torr. The contours of the aerowindow are such that a pressure gradient is formed in the supersonic flow by Prandtl-Meyer expansion waves across which the beam propagates into the vacuum chamber. The supersonic gas flow enters the diffuser, recovers the flow pressure back to atmospheric conditions, and ejects into the atmosphere. The supply pressure upstream of the supersonic nozzle can be varied to achieve optimum performance. When the filament enters the vacuum it diffracts because no self-focusing occurs in the absence of air. After a distance of 2.4 m, a filament at a wavelength of 250 nm has diffracted to a size, w, where
w=w₀\sqrt{1+(z/z₀)2}=19×w₀=1.9 mm
where w₀=100 μm is the beam waist and z₀=πw₀²/λ=12.6 cm is the Rayleigh range. The intensity is reduced by a factor of 360 and can be further attenuated by reflecting the diffracted beam out of the chamber using a glass slide. The remaining intensity I is then (0.05/360=1.4×10⁻⁴×I₀) 140 MW/cm² in the UV and 14 GW/cm² in the IR, sufficiently low for optical components. In an embodiment, an aerowindow is configured for a pressure on the vacuum side of <50 Torr with a 3 mm entrance hole.

FIG. 6 shows that without additional suction the low pressure side reaches about 84 Torr. In FIG. 6, the graph shows pressure on the vacuum side versus inlet pressure for three different cases: aerowindow by itself (triangle) 610, one pump attached (circle) 620, and three pumps attached (rectangle) 630. Vacuum pump suction is required to achieve about 37 Torr (one pump) and about 5 Torr respectively (3 pumps). Apparently, boundary layer separation occurs in the adverse pressure gradient region as the flow enters the diffuser section, which prevents sufficient expansion to reach about 40 Torr on its own. Future improvements to the aerowindow should decrease the vacuum pressure considerably.

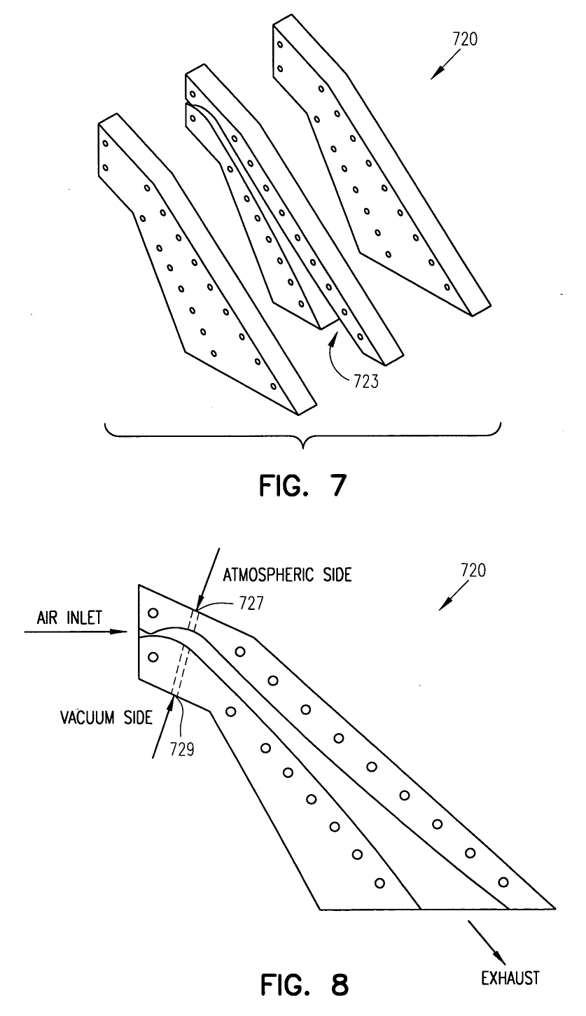

FIG. 7 shows an embodiment of an expanded view of an aerodynamic window used for launching or diagnosing filaments. Aerodynamic window 720 has a channel 723 for fluid flow. In an embodiment, the fluid flow is a supersonic fluid flow. The profile cut with a wire cutting machine is clamped between two plates. The depth of the profile is more than 10 times the spacing at the nozzle. Small holes 727, 729 in aerodynamic window 720 for passage of the filament are indicated in FIG. 8.

Ultrashort light pulses (100 fs) of a few millijoule energy have sufficiently high peak power to self-focus in air. Even more interestingly, such self-focused pulses have been observed to create their own waveguide or filament in air, and propagate over tens of meters. The intense white light continuum generated with this process has been observed in backscattering over 13 km. In a reported experiment, a light filament was directed towards the sky, and the recorded spectra indicated that the white light created by the filament can be successfully used for absorption measurements and monitoring of the atmospheric components.

Studies have been limited to femtosecond pulses around 800 nm. At that wavelength, the filamentation process is complex, and cannot be scaled to long pulsewidth. Recent measurements, supported by theoretical simulations, indicate indeed that the stabilizing process in UV filaments is mainly a balance between self-focusing in air and the self-defocusing of the electron plasma created by 3-photon ionization of air. Since this is an intensity dependent process these filaments could be scaled to longer pulse duration and higher pulse energies, making them a means to transport pulses of the order of Joules, in a 100 micron diameter channel, over kilometers distances, with intensities of tens of GW/cm².

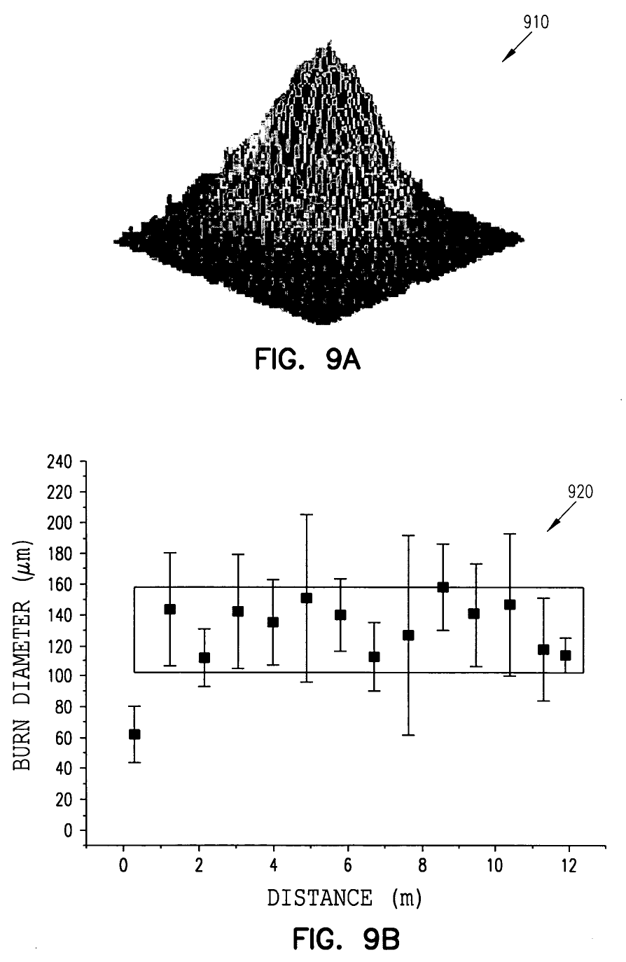

In an experiment with UV beams, a 20 to 50 mJ UV beam is collimated with a diameter of about 1 cm. A manifestation of the filament is to put an obstacle in the beam and the size of the hole made by the filament is measured as shown in FIGS. 9A, 9B. FIG. 9A shows a 3D representation of a plasma plume 910 produced by a filament impinging on steel. The original pulse duration is 1 ps. The energy trapped in a single filament is 0.2 mJ. The full width to half maximum (FWHM) of the plasma flume is 100 μm. The graph 920 of FIG. 9B shows the diameter of the hole made by the filaments in solid material placed at various distances from the source. The Raleigh range (the length over which the beam cross-section has diffracted to twice its original cross section) corresponding to about a 248 nm beam of 140 μm is only of the order of approximately 10 cm. The holes have a diameter of 140 μm and are observed between one and 12 meter from the source. Another approach to measure the filament size is to image plasma plume 910 produced on impact of the filament with a steel surface. The diameter (full width at half maximum) of that image is 100 μm.

Measurements of multiphoton ionization combined with conductivity measurements have indicated an electron concentration of 2×10¹⁵ e⁻/cm³. This is in agreement with theoretical simulations showing that the 3-photon ionization of oxygen in the filament produced an electron plasma which stabilizes the filament by defocusing, balancing the self-focusing action of air. This mechanism is purely intensity dependent.

Comparative measurements of the ionization with IR filaments have been made and showed the electron ionization in these filaments to be twenty times smaller, even though the energy in the IR filament is 50 times larger. The mechanism of stabilization of IR filaments is much more complex, and specifically involves the femtosecond duration of these pulses. Another difference between IR and UV filaments is that in the latter case there is no loss of energy from the filament into “conical emission”.

A series of experiments with pulse durations varying from 500 fs to 2.5 ps have been conducted. In all these cases, the peak intensity in the filament is the same (1.4 TW/cm²). The theory, developed by the group under Professor Moloney in Tucson, Ariz., corroborates the experimental findings, namely that longer pulses produce filaments with the same peak intensity, but higher energy is stored, and they should propagate over a longer distance.

It has been determined experimentally that the only loss mechanism is 3-photon ionization. The light trapped in the filament looses energy at a rate of 40 μ/m. This is quite significant for a filament of only 150 μJ created by a 500 fs pulse.

The pulse duration limit is reached when the multiphoton ionization process is overpowered by avalanche ionization. This takes place if the energy gained by one electron by inverse Bremstrahlung equals the ionization energy. The maximum pulse duration, for a given ionization energy, scales as 1/(I×λ²), where I is the intensity in the filament and λ is the wavelength. Clearly, the shorter the wavelength, the longer the pulse duration limit at a given filament intensity. As compared to the IR filament, the pulse duration limit imposed by this condition is about 2,000 times longer for UV pulses. The limit for the UV pulse is estimated on the order of a nanosecond, which implies that a pulse energy close to a Joule could be trapped in a filament, propagating for 1 J/(40 10⁻⁶ J/m)=25 km! A filament of that energy can obviously produce strong laser damage at far distances. One of the most exciting properties of these filaments is that they are much smaller than the characteristic size of atmospheric turbulence, hence they do not seem to be affected by such turbulence.

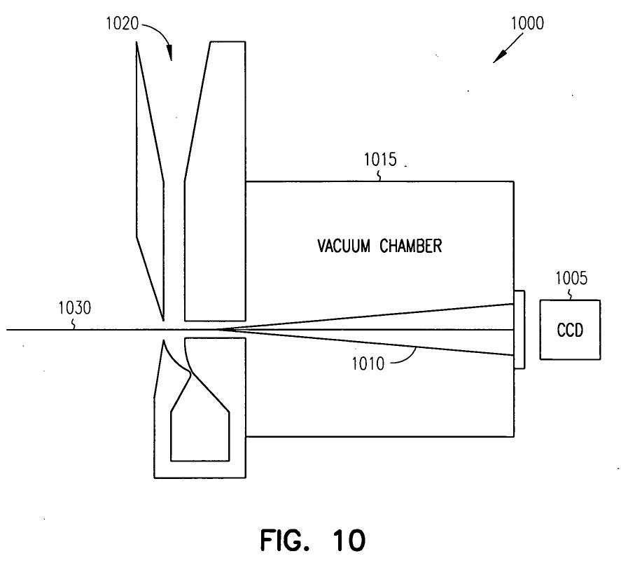

The analysis of filaments has been limited to the crude measurements as cited above, because any material put in the path of the filament suffers some damage or transformation. Spectroscopic measurements have been plagued by the fact that reflections off solid or liquid targets produce plasma with much brighter emission than the one associated with the filament itself. In an embodiment, this problem is addressed through the use of aerodynamic windows between air and vacuum. Once in vacuum the 100 μm diameter filament will diffract with an angle of at least 10⁻⁴ radian. After a propagation distance of 2 m in vacuum, the intensity is reduced 250 times, hence below the damage threshold of good optics. An embodiment of an arrangement of a system 1000 for studying and measuring parameters of a filament with an aerodynamic window is shown in FIG. 10.

In the embodiment of FIG. 10, a diffracted version 1010 of a filament 1030 is observed with a CCD system 1005. At the time of measurement, compressed air of nitrogen is released in the high pressure chamber, at the same time that a mechanical aperture opens to a vacuum chamber 1015. The filament is sent through a 1 cm aperture in aerowindow 1020, and diffracts in vacuum chamber 1015, to be analyzed after diffraction and transmission through a window.

A system using an aerodynamic window makes it possible to make measurements of the spectrum, duration, shape, and phase modulation of the pulse inside the filament. From the diffracted pattern, the spatial field distribution inside the filament can be inferred, allowing for much more quantitative and accurate comparisons with theoretical calculations than have been possible previously.

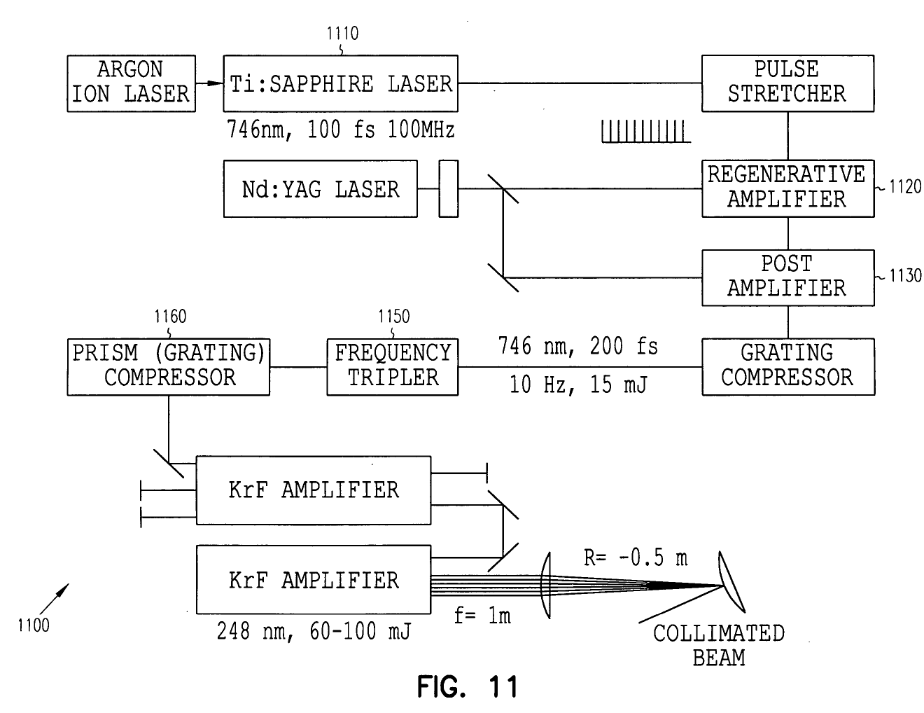

FIG. 11 depicts an embodiment of a laser system 1100 that may be used with an aerodynamic window to launch a filament. In an embodiment, a source used for the filamentation generation is a Ti:sapphire based laser system 1110, followed, after frequency tripling, by two excimer amplifiers. As shown in FIG. 11, a train of 100 fs pulses at 100 MHz is stretched to 200 ps before being sent to a regenerative amplifier 1120 and a multipass amplifier 1130. The pulses are re-compressed to 200 fs, frequency tripled, and sent successively through a 3 path and 2 path excimer amplifier. A compressor 1160 consisting of a pair of prisms can be inserted after the frequency tripler 1150 to compensate for dispersion in the excimer amplifiers. The minimum pulse duration achieved in that configuration is 500 fs. A pair of gratings is substituted for the prism pair when pulse stretching is desired. In an embodiment in those applications in which the quality of the profile of the UV beam leaving the excimer needs improvement and spatial filtering does not provide the desired beam quality, adaptive optics in the amplifier chain may be used to obtain a reproducible Gaussian beam profile for the characterization of filaments. Embodiments of systems and methods according to the teachings of the present invention are not limited by the types of lasers and peripheral optical devices described herein as examplary embodiments.

An aerodynamic window in a system provides the means and method for controllably launching filaments into the atmosphere. Systems using filaments launched utilizing an aerodynamic window have a wide variety of applications that use high intensity energy in a small spot size from a source of electromagnetic radiation such as provided by a laser. In addition, an aerodynamic window in a system provides the means and method for characterizing filaments propagating through the atmosphere using conventional diagnostic tools for studying properties of electromagnetic energy propagating through a medium.

Although specific embodiments have been illustrated and described herein, it will be appreciated by those of ordinary skill in the art that any arrangement which is calculated to achieve the same purpose may be substituted for the specific embodiment shown. This application is intended to cover any adaptations or variations of the present invention. It is to be understood that the above description is intended to be illustrative, and not restrictive. Combinations of the above embodiments, and other embodiments will be apparent to those of skill in the art upon reviewing the above description. The scope of the invention includes any other applications in which the above structures and fabrication methods are used.

1. An apparatus comprising:
a first region to receive electromagnetic radiation;
a second region; and
an aerodynamic window coupling the first and second region, the aerodynamic window having an aperture to propagate the electromagnetic radiation from the first region to the second region, wherein the aerodynamic window is configured to provide a pressure gradient from the first region to the second region.

2. The apparatus of claim 1, wherein the aerodynamic window includes a channel having the aperture, the channel configured to direct a supersonic gas flow across a path of the electromagnetic radiation.

3. The apparatus of claim 1, wherein the apparatus includes a laser to provide the electromagnetic radiation as a laser beam.

4. The apparatus of claim 1, wherein the apparatus is adapted to receive the electromagnetic radiation as a filament of laser light.

5. The apparatus of claim 1, wherein the first region is adapted to provide substantially an atmospheric pressure.

6. The apparatus of claim 1, wherein the first region is adapted to substantially provide a pressure of about 50 Torr or a pressure less than 50 Torr.

7. The apparatus of claim 1, wherein the second region is adapted to provide substantially an atmospheric pressure.

8. The apparatus of claim 1, wherein the second region is adapted to substantially provide a pressure of about 50 Torr or a pressure less than 50 Torr.

9. The apparatus of claim 1, wherein the apparatus includes diagnostics to characterize the electromagnetic radiation, the diagnostics coupled to the second region, the second region configured as a vacuum chamber.

10. The apparatus of claim 9, wherein the diagnostics includes a CCD system.

11. The apparatus of claim 1, wherein one of the first region or the second region is configured to provide a controlled atmosphere and the other region is configured to provide a pressure of about 50 Torr or a pressure less than 50 Torr.

12. The apparatus of claim 1, wherein the first region is configured with optics to focus the electromagnetic radiation such that the optics have a focal plane in the aerodynamic window that interfaces the first and second regions.

13. The apparatus of claim 1, wherein the first region is configured with optics to focus the electromagnetic radiation to a beam having a diameter on the order of 100 μm.

14. The apparatus of claim 1, wherein the apparatus includes a beam shaping system coupled to the first region to profile a predetermined spatial profile for the electromagnetic radiation to generate multiple filaments of electromagnetic radiation in the second region.

15. The apparatus of claim 1, wherein the apparatus is a system configured such that its operation includes generation of a filament of electromagnetic radiation.

16. The apparatus of claim 1, wherein the apparatus is a system configured such that its operation is adapted to detect a filament of electromagnetic radiation.

17. The apparatus of claim 16, wherein the system configured such that its operation is adapted to detect a filament of electromagnetic radiation includes the system configured such that its operation is adapted to diagnose the filament of electromagnetic radiation.

18. An apparatus comprising:
a laser to provide a laser beam;
a first region to receive the laser beam;
a second region; and
an aerodynamic window connecting the first and second region, the aerodynamic window including a channel having a entry aperture and an exit aperture to propagate the laser beam from the first region to the second region and having a high pressure inlet and nozzle to provide a supersonic flow, wherein the aerodynamic window is configured to provide a pressure gradient across the supersonic flow from the first region to the second region.

19. The apparatus of claim 18, wherein the first region is configured to have a pressure of about 50 Torr or less than 50 Torr, and the second region is configured to have a controlled atmosphere.

20. The apparatus of claim 19, wherein the controlled atmosphere has a substantially atmospheric pressure.

21. The apparatus of claim 18, wherein the first region is configured with optics to focus the laser beam such that the optics have a focal plane in the aerodynamic window that interfaces the first and second regions.

22. The apparatus of claim 18, wherein the first region is configured with optics to focus the laser beam to a beam having a diameter on the order of 100 μm.

23. The apparatus of claim 18, wherein the apparatus includes a beam shaping system coupled to the first region to profile a predetermined spatial profile for the laser beam to generate multiple filaments of laser light.

24. The apparatus of claim 18, wherein the apparatus is a system configured such that its operation includes generation of a filament of laser light.

25. An apparatus comprising:
a first region to receive a filament of laser light;
a second region; and
an aerodynamic window connecting the first and second region, the aerodynamic window including a channel having a entry aperture and an exit aperture to propagate the filament from the first region to the second region and having a high pressure inlet and nozzle to provide a supersonic flow, wherein the aerodynamic window is configured to provide a pressure gradient across the supersonic flow from the first region to the second region.

26. The apparatus of claim 25, wherein the second region is configured to have a pressure of about 50 Torr or less than 50 Torr, and the first region is configured to have a controlled atmosphere.

27. The apparatus of claim 26, wherein the controlled atmosphere has a substantially atmospheric pressure.

28. The apparatus of claim 25, wherein the apparatus includes diagnostics to characterize the filament of laser light.

29. The apparatus of claim 28, wherein the diagnostics includes a CCD system.

30. The apparatus of claim 25, wherein the apparatus is a system configured such that its operation includes diagnosis of the filament of laser light.

31. A method comprising:
providing electromagnetic radiation;
introducing the electromagnetic radiation into a first region;
directing the electromagnetic radiation through an aperture in an aerodynamic window coupling the first region to a second region, wherein the aerodynamic window provides a pressure gradient from the first region to the second region.

32. The method of claim 31, wherein the method includes providing a supersonic gas flow in the aerodynamic window such that the electromagnetic radiation crosses the supersonic gas flow.

33. The method of claim 32, wherein providing electromagnetic radiation includes providing a laser beam to generate a filament of laser light.

34. The method of claim 33, wherein the method includes providing the first region with a pressure of about 50 Torr or a pressure less than 50 Torr and providing the second region with a controlled pressure.

35. The method of claim 33, wherein providing the second region with a controlled pressure includes providing the second region with a pressure that is substantially atmospheric.

36. The method of claim 33, wherein the method includes focusing the laser beam as it enters the first region to provide a focal plane in the aerodynamic window at an interface the first and second regions.

37. The method of claim 33, wherein the method includes focusing the laser beam as it enters the first region to provide a beam having a diameter on the order of 100 μm.

38. The method of claim 33, wherein the method includes applying beam shaping to the laser beam to generate a predetermined wavefront for the filament to produce a predetermined pattern of filaments.

39. The method of claim 32, wherein providing electromagnetic radiation includes providing a filament of laser light.

40. The method of claim 39, wherein the method includes providing the second region with a pressure of about 50 Torr or a pressure less than 50 Torr and providing the first region with a controlled pressure.

41. The method of claim 40, wherein providing the first region with a controlled pressure includes providing the first region with a controlled pressure that is substantially atmospheric.

42. The method of claim 39, wherein the method including varying the pressure upstream from the supersonic gas flow.

43. The method of claim 39, wherein providing a supersonic gas flow in the aerodynamic window includes providing a supersonic air or nitrogen stream.

44. The method of claim 39, wherein the method includes detecting a diffracted pattern generated by the propagation of the filament into the second region.

45. The method of claim 44, wherein the method includes measuring characteristics of the detected diffracted pattern.
